(19) United States
(12) Patent Application Publication
(10) Pub. No.: US 2002/0179518 A1
(43) Pub. Date: Dec. 5, 2002

(54) Dialysis machine with disinfectant function

(76) Inventor: Kuo-Hsin Ho, Sanchung City (TW)

Correspondence Address: JACOBSON, PRICE, HOLMAN, & STERN, PROFESSIONAL LIMITED LIABILITY COMPANY, 400 Seventh Street, N.W., Washington, DC, 20004, US

(21) Appl. No.: 09/865,421

(22) Filed: May 29, 2001

(51) Int. Cl. B01D 61/30; B01J 19/12

(52) U.S. Cl. 210/321.71; 210/252; 422/186.07; 422/186.04

(57) ABSTRACT

The present invention relates to a dialysis machine with an ozone generator. Two dialysate delivery pumps connect to a diluting tube inside the dialysis machine respectively, each of which is joined with a drug container. Reversed Osmosis water is drawn from one end of the diluting tube, flows into the drug container for producing the drugs of dialysate or chemicals for disinfection. While the other end of the diluting tube is connected to a dialyzer. The improvement of the device is in that an ozone generator is connected to the water inlet end of the diluting tube. The ozone generator includes an anode and a cathode for electrolysis of water. Water decomposes to hydrogen and ozone gas. The diluting tube is disinfected by ozone so as to avoid inconvenience of disinfecting and sterilizing the diluting tube and the risk of exposure to residual disinfectant chemicals.

### BACKGROUND OF THE INVENTION

1. Field of the Invention

The present invention relates to a dialysis machine, more particularly, to a dialysis machine with an ozone generator being connected to the water inlet of the diluting tube for producing ozone in order to disinfect the diluting tube. Thus the inconvenience of disinfecting and sterilizing the diluting tube of the dialysis machine and the risk of residual sterilant inside the diluting tube can be avoided.

2. Description of the Prior Art

Dialysis machine encompasses an extracorporeal circuit for blood circulation and a dialysate fluid circuit. The extracorporeal circuit includes a blood tubing and a blood pump. The blood tubing is connected to patient's arm through a needle. One end of the blood tubing takes blood from patient's artery to dialyser while the other end returns blood to patient via vein. The blood pump is arranged between the patient and the dialyzer, and compresses tubing in order to force blood along tube.

On dialysate fluid circuit, purified water is drawn through the water inlet into the diluting tube by two dialysate delivery pumps. Each pump is connected to a drug container with drug concentrate therein. The water mixed with the concentrate in specific ratio to produce dialysate. Then the dialysate fluid is delivered through the water outlet of the diluting tube into the dialyzer. Inside the dialyzer, blood is exposed to dialysis fluid (dialysate) for exchange of excess fluid, ions, and toxic wastes.

However, the intramural environment may play an important role in the transmission of infectious diseases in hemodialysis machine. After finishing each hemodialysis cycle, the next patient faces exposure to infectious microorganisms.

The risk of infection can be minimized by performing the necessary equipment cleaning following each treatment.

During traditional disinfection cycle, the drug container connected with the dialysate delivery pump is replaced by a container with virulent sanitizing agents such as formalin or peracetic acid. Then the sterilant is transmitted into the diluting tube by the dialysate delivery pumps. These chemicals are useful sterilant for dialyzer reprocessing and are effective against most kinds of microorganisms. But it takes long time to finishing the disinfectant treatment by this way. At the same time, patients are also exposure to hazardous chemicals residual inside the tube.

### SUMMARY OF THE INVENTION

It is therefore a primary object of the present invention to provide a dialysis machine with an ozone generator at the water inlet end of the diluting tube so as to disinfect the diluting tube without using noxious sanitizers.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is a schematic drawing of tubes in accordance with the present invention.

FIG. 2 is a schematic drawing of pipeline of the ozone generator in accordance with the present invention.

### DETAILED DESCRIPTION OF THE PREFERRED EMBODIMENT

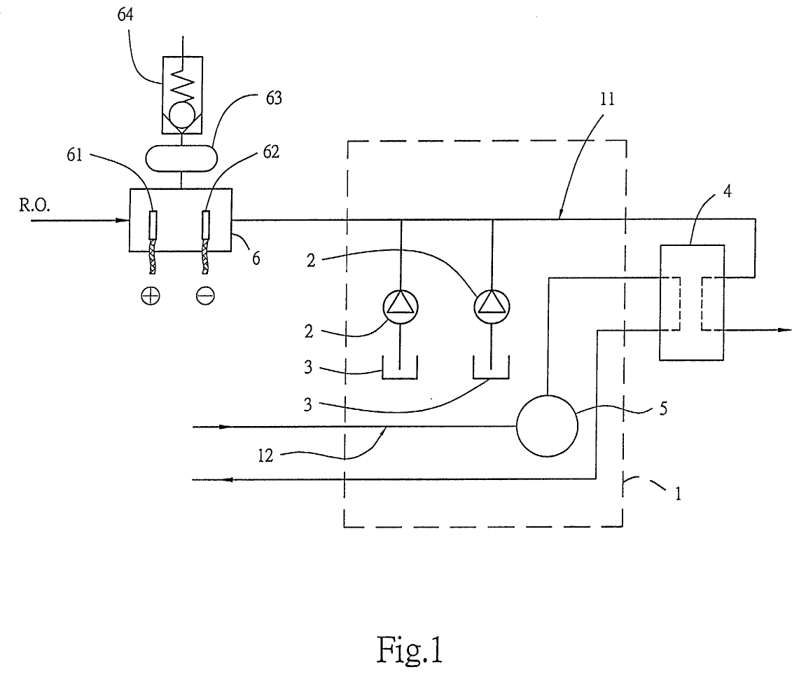

Refer to FIG. 1, on one end of the artificial dialysis machine 1, a diluting tube 11 for dialysate connects to two dialysate delivery pumps 2 sequentially, each of which is joined with a drug container 3. Reversed Osmosis water is drawn from one end (water inlet) of the diluting tube 11 for diluting the drugs of dialysate or chemicals for disinfection insdie the drug container 3 while the other end (water outlet ) of the diluting tube 11 is connected to a dialyzer 4. A blood circulation 12 is connected to the other end of the dialyzer 4 with a blood pump 5 thereof.

The device features on that an ozone generator 6 is installed at the water inlet end of the diluting tube 11. The ozone generator 6 includes an anode 61 and a cathode 62, both of which decompose the pure water into ozone and hydrogen gas. Ozone is an extremely powerful biocide and is applied on the disinfecting and sterilizing the diluting tube 11 of the artificial dialysis machine 1. An air container 63 is disposed on the top of the ozone generator 6 and is connected to a decompression valve 64 used for exhausting the hydrogen produced during the electrolysis process.

According to the structure mentioned above, during the renal dialysis, the anode 61 and the cathode 62 inside the ozone generator 6 don't react with each other. Only the pure water is conducted into the diluting tube 11 of the artificial dialysis machine 1. Following each treatment, the anode 61 and the cathode 62 inside the ozone generator 6 decompose the water in order to produce ozone for cleaning and sterilizing the diluting tube 11.

During the procedure for generating ozone from the anode 61, the hydrogen gas from cathode 62 is stored in the air container 63. When the pressure of the hydrogen inside the air container 63 achieves a certain level, the hydrogen gas will be released through the decompression valve 64.

The disinfecting and sterilizing effect of ozone is no less than conventional chemical disinfectant such as formalin, peracetic acid or acetic acid. And the ozone is innocuous, not corrosive thus with higher safety than other sterilants. In addition, after finishing disinfecting procedure, ozone is not residual in side the wall of the diluting tube 11.

Moreover, the anode 61 and the cathode 62 for producing ozone are both installed inside the ozone generator 6 so that ozone produced inside the ozone generator 6 is conducted directly into the diluting tube 11. Ozone does not contaminate the inner wall of the diluting tube 11, since its breakdown products are oxygen and water. Thus there is no need to wash the diluting tube 11 again after the disinfecting procedure.

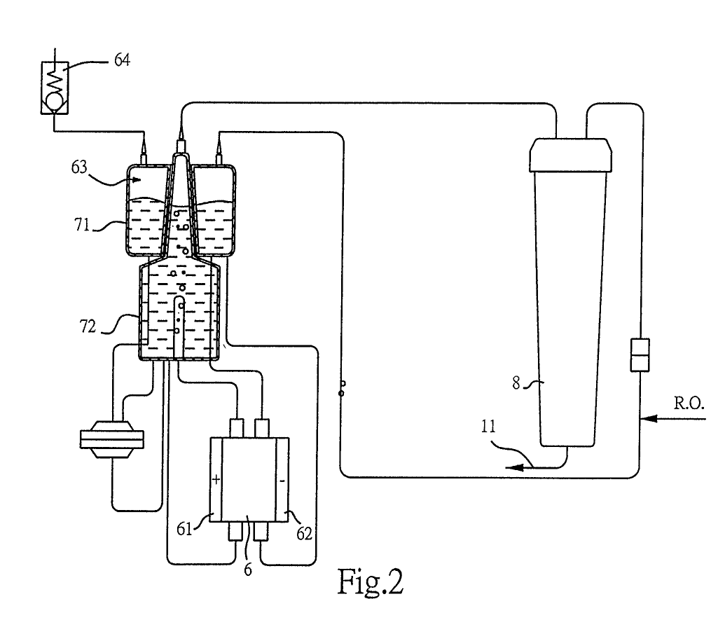

Refer to FIG. 2, the anode 61 and the cathode 62 of the ozone generator 6 are connected to an upper water tank 71 and a lower water tank 72 respectively. While the lower water tank 72 is connected to a gas-water mixer 8 by a pipe. R.O. water is conducted into the gas-water mixer 8 from the water inlet end while the diluting tube 11 is jointed with the water outlet end of the gas-water mixer 8. The upper water tank 71 is connected to the air container 63 and the decompression valve 64.

Ozone generating from the anode 61 of the ozone generator 6 is discharged through the lower water tank 72, into the a pipe into the gas-water mixer 8, after being mixed with R.O. water, and run into the diluting tube 11. While the hydrogen gas from cathode 62 is released into the air container 63 connected with the upper water tank 71. When the pressure of the hydrogen inside the air container 63 achieves a certain level, the hydrogen gas will be released through the decompression valve 64.

It is to be understood that the drawings are designed for purposes of illustration only, and are not intended for use as a definition of the limits and scope of the invention disclosed.

What is claimed is:

1. A dialysis machine with disinfectant function including
a diluting tube for delivering dialysate,
two dialysate delivery pumps being connected to the water inlet end of said diluting tube respectively and with a drug container for mixing water with drug therein,
a dialyzer connected with the water outlet end of said diluting tube,
a blood circulation being connected to said dialyzer with a blood pump thereof,
an ozone generator having an anode and a cathode,
an air container with a decompression valve,
wherein the improvement comprises
said ozone generator being installed at the water inlet end of said diluting tube,
said anode and said cathode decompose water to hydrogen and ozone gas for disinfecting of said diluting tube by ozone,
said air container with a decompression valve is disposed at the top of said ozone generator for exhausting hydrogen from the electrolysis of water.
